(19) United States
(12) Patent Application Publication
(10) Pub. No.: US 2006/0057255 A1
(43) Pub. Date: Mar. 16, 2006

(54) Tamper evident bunch wrapper packaging

(76) Inventors: James Teal, Lititz, PA (US); Mitch Lapman, Elizabethtown, PA (US); Denny Ng, Hackettstown, NJ (US)

Correspondence Address: FITZPATRICK CELLA HARPER & SCINTO, 30 ROCKEFELLER PLAZA, NEW YORK, NY, 10112, US

(21) Appl. No.: 10/938,665

(22) Filed: Sep. 10, 2004

(51) Int. Cl. A22C 17/10

(52) U.S. Cl. 426/87

(57) ABSTRACT

A bunch wrap package comprises edges of the wrapper material gathered on a surface of an edible product, and an image formed over the gathered edges to provide evidence of tampering.

### BACKGROUND OF THE INVENTION

1. Field of the Invention

The invention is directed to a bunch wrap package that will provide evidence of tampering, and to methods of making a tamper evident bunch wrap package. The packaging and methods are especially useful for wrapping edible products, such as small molded chocolate pieces, to provide evidence of tampering.

2. Description of the Related Art

Confectionery products are handled by a large number of people at the point of sale prior to being finally purchased and consumed. This raises a concern that these products are likely to be subjected to tampering. Thus, it is desirable to provide evidence of tampering to packaging associated with confectionery, and in particular for a bunch wrap package. Typically the concern is after sale of a bag and prior to consumption. Display in a bowl in an office situation or distribution for Halloween are good examples.

A bunch wrap package is closed by “bunching” the wrapper material (which holds a crease when it is folded) against a side of the product, and it is generally not sealed. These packages are typically opened by unfolding the material where the loose edges are compressed. The package is then easily re-closed by again folding and compressing the material around the product. Therefore, this type of packaging does not readily provide evidence that the packaging has been previously opened or tampered with from the time of its manufacture. An edible product in this type of packaging may be vulnerable, and the product itself may be perceived as unsafe.

Edible products are conventionally bunch wrapped by pushing an edible product and a foil wrapper through a die, cutting the foil, and gathering the edges on a side of the product using brushes and fingers to press the free edges against the side. The raised edges are then typically compressed further, such as with a belt cooperating with a conveyor belt on which the individual pieces are conveyed.

Most non bunch wrap packages are sealed where the edges of the packaging material come together by means such as adhesives and heat sealing, so that the product is loosely contained in the package. As a result, the packaging does not conform to the outer contours of the product, and the consumer cannot easily perceive the shape of the product. With bunch wrap packaging, the package is designed to conform to the shape of the product so that the detail of the product shape can be seen underneath the packaging material. To have the material completely cover the product, and to allow the material to be cut from package stock as a simple rectangular piece, the packaging material (such as foil) is oversized so that the edges overlap each other rather than meet, and the package is closed by bunching the edges against a surface of the product. If an adhesive were used on the edges to keep them together under these circumstances, there is a high probability that the adhesive material would contact the product inside the package.

Methods for providing evidence of tampering for packaging of this type are disclosed in U.S. patent application Publication No. 2004-0112010 A1, which describes the use of specially designed adhesive labels for this purpose. However, the additional packaging element increases the cost of the product packaging and increases the complexity of manufacture. The tamper evident package disclosed herein is an alternative tamper-evident design.

### SUMMARY OF THE INVENTION

In one aspect, the invention is a tamper evident bunch wrap package for an edible product having a wrapping material conforming to an outside shape of the edible product and having edges gathered on a surface of the product. An image is formed on the gathered edges so that opening the bunch wrap package by unfolding the gathered edges provides evidence of tampering by visible corruption of the image.

The image may be formed by known means, including ink jet printing, contact printing, laser etching, embossing, and debossing. The lines of the image are sufficiently thick so that a disturbance in the image is visible when a change in the placement of creases, folds and edges occurs when the package is opened, and the image is sufficiently large relative to the side of the product on which the image appears so that an edge cannot be tampered with without disrupting the image.

In one embodiment, the image is formed by applying adhesive on the gathered edges. In this case, the evidence of tampering is provided not only by the disruption/distortion of the image but also by the inevitable tearing that occurs when the edges are peeled away from the product.

A method for providing evidence of tampering to a bunch wrap package comprises providing a product partially wrapped in a wrapping material; gathering edges of the wrapping material on a surface of the product; compressing the gathered edges of the wrapping material; and forming an image on the compressed gathered edges of the wrapping material to provide evidence of tampering.

A partially wrapped product may be provided by pushing the product and a bunch wrapper through a die to partially wrap the product; alternatively, the product could be partially wrapped by other means, such as by hand.

### BRIEF DESCRIPTION OF THE FIGURES

FIG. 1a depicts an embodiment of the invention in which a laser device is used to etch an image on the creased folds of a wrapper gathered on a flat side of the edible product.

FIG. 1b depicts an embodiment of the invention in which an embossing belt is used to form the image.

### DETAILED DESCRIPTION OF THE PREFERRED EMBODIMENT

“Tamper evident” as used herein means providing any visible indication that a package has been opened or that an attempt has been made to open it. A tamper evident image is an image printed on the creased edges of a bunch wrap package such that the image is disturbed if an attempt is made to open it. Of course, an undisturbed tamper evident image provides evidence that the edible product has not been tampered with, which is also “evidence of tampering.” As used herein “visible corruption of the image” includes a visually noticeable change in the image which may be, for example, a disturbance, disruption and/or distortion of the image.

“Bunch wrapping,” as used herein, means wrapping an object with a sheet of wrapping material; conforming the material to the outside shape of the object; and bunching the edges of the sheet of material against a surface of the object. This definition is consistent with the usage in the art. The “Glossary of Packaging Terms,” published by the Packaging Institute International, for example, defines bunch wrap as “a method of wrapping with the packaging material gathered on the underside.” As a practical matter, an effective bunch wrapper material has dead fold properties. Dead fold is defined in the Glossary of Packaging Terms as “a hand or machine made fold which will remain in position without sealing, such as a soft foil.” Preferred wrapper materials are foils and laminated foils, such as a soft temper foil having a thickness of about 6 microns to about 40 microns, and more preferably about 8 microns to about 20 microns.

“Partially wrapped” means that a product has been contacted and at least partly surrounded with a wrapping material, but the wrapping material has not been completely compressed against the surface of the product as it is in the final bunch wrap configuration.

A variety of shaped products may be provided in a tamper evident bunch wrap package according to the invention, including without limitation bars tablets, and ovoids, which are associated with popular confectionery items. The products may have curved surfaces, flat surfaces, or a combination of curved and flat surfaces. In certain preferred embodiments the products wrapped according to the invention are small molded pieces having at least one flat surface.

Bunch wrapping may be accomplished by methods known in the art, such as by pushing the edible product into a sheet of wrapper material through a die with brushing members conforming the wrapper material to the piece. Finger members then push the trailing ends against the piece. If the pieces are quite small, as with bite size molded chocolate pieces, they are then conveniently conveyed on a conveyor belt. A second belt, cooperating with the conveyor belt is provided to compress exposed edges of the bunch wrapper against the side of the product. These and other methods, being known in the art, will not be elaborated upon herein, expect as pertains to the invention.

The product contained in the bunch wrapper can be of any type of product, edible or non-edible, where evidence of tampering is desirable. Preferably the product is an edible product for a human or an animal. Most preferably this is a confectionery product. In one preferred embodiment, the product is a molded chocolate piece.

In preferred embodiments, the edible product has at least one flat side, and the edges of the wrapper are gathered on a flat side of the product. By gathering the edges on a flat side of the product, application of the image over the gathered edges is easier. In the most preferred embodiment, the edible product is a molded chocolate confectionery piece, which has a flat side owing to the molding process. The flat side also makes it easier to bunch the edges of the wrapper against that side.

Conventionally, according to the prior art, bunch wrap packaging material is printed with graphics prior to being applied to the product for ease of manufacture. Because of the process of applying the material to the package, images that the manufacturer desires the consumer to view are configured to appear on the smooth surface of the product rather than on the bunched edges of the wrapper, where the image would be distorted by the creases and folds of the material as it is compressed around the product. Since this image is pre-printed on the material and typically configured to appear on the packed product without folds and creases appearing in the image, changing the orientation of the edges or the creases during opening and reclosing will not distort the image. Conversely, the inventive bunch wrap packaging of this invention has the image applied over the gathered and creased edges of the packaging material. In order for the image to be undistorted, the image must be applied after the material is compressed around the product.

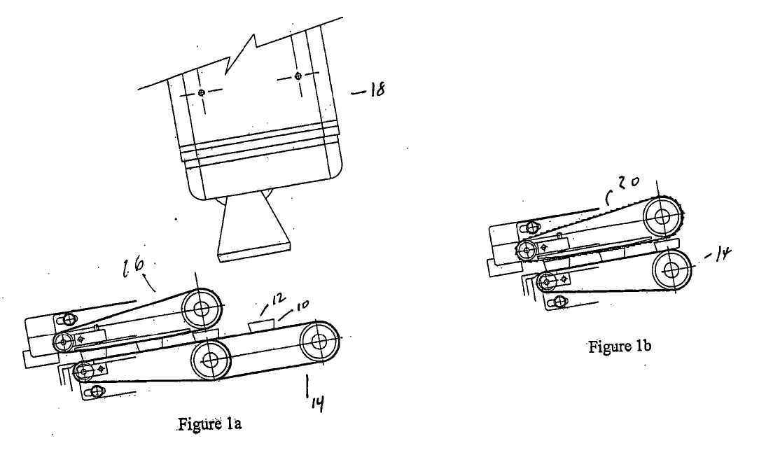

In a preferred embodiment, shown in FIG. 1a, the edible products 10 are relatively small molded chocolate pieces having a flat side 12. The pieces are conveyed on a conveyor belt 14 and a second belt 16 compresses the exposed edges of the wrapper. Laser device 18 etches a pattern in the wrapper. It is necessary to operate the laser at a temperature and for a period of time such that the chocolate is not melted significantly during the packaging process.

In another preferred embodiment, the image is ink jet printed. To print an ink jet image on the compressed side of the bunch wrapper. A drop-on demand ink jet head is preferably used as it is capable of providing better image resolution, greater than about 100 dots per inch (dpi). However, continuous ink jet printheads, which provide a lower dpi, may also be used.

Contact printing means may also be used to apply the tamper evident image to the bunch wrap package. For example, an offset roller or other contact member may be provided with an ink laden image such as by using a pad or transfer roller or other suitable means, and the ink image may then be pressed onto the bunch wrap package. Where contact printing methods are used, it is necessary to ensure that the contact member does not damage the piece, and therefore in some cases non-contact printing means are preferred.

Any ink may be used that will provide a satisfactory contrast and drying time on the wrapper surface including solvent, water, fat and wax based inks Preferred inks are fast drying inks, which can dry in less than about 5 seconds, and FDA approved edible inks. Some preferred inks include solvent based inks available, for example, from Markem Corporation (Keene, N.H.), Mathews International Corporation (Pittsburgh, Pa.), or Imaje USA (Kennesaw, Ga.).

As shown in FIG. 1b, another embodiment involves embossing or debossing. In this embodiment, embossing belt 20 is provided with a raised image integrated into the belt which impresses an image into the dead fold area of the wrapper. Embossing can be achieved by any known method in the art as long as the force applied to the bunch wrapped product does not damage that product, for example a single or multiple forming tools can be used to apply the embossed image. Debossing is essentially the inverse process, in which an area of the wrapper is sucked into a cavity by vacuum to form a raised image with the bunch wrap material. Generally, the minimum depth or height of an embossed or debossed mark is about 3/32 inch (2.4 mm) to ensure visibility.

Preferably, so that none of the edges can be opened without disturbing the tamper evident image, the image has a width at least about 25 percent, preferably 50 percent the width of the side on which the image is printed. More preferably, the image has a width greater than about 75 percent of the width of the printed side. In the most preferred embodiment, the image extends substantially across the entire back side of the edible product. Preferably the image is at least half an inch, more preferably three quarters of an inch, most preferably at least one inch. There could be more than one image on a surface, particularly if the bar is larger.

Likewise, the lines of the image itself must be sufficiently bold and contrasting that they can be recognized as providing evidence of tampering. In general a line width of at least about 1/16 inch (1.6 mm) is preferred. If an image is composed entirely of lines, then in preferred embodiments, each such line should have a line width at least about 1/16 inch (1.6 mm). Where the image is not composed entirely of lines, then “line width” refers simply to measurement from side to side of the image at its narrowest point. In preferred embodiments, the narrowest continuous printed or embossed portion of the image has a width from side to side at least about 1/16 inch (1.6 mm).

As used herein, “width” of an image refers to distance from the extreme left side of the image to the extreme right side of the image when the image is viewed in its normal orientation. The image may be oriented with respect to any dimension of the side of the product on which it is printed.

Generally, the bunch wrap package is not sealed with an adhesive or otherwise. However, in one embodiment described herein, an adhesive is formed on the exposed creased edges of the bunch wrapper in the form of an image. One of ordinary skill in this art will appreciate the difference between an adhesive formed on an exposed portion of a package in the form of an image, versus an ordinary seal in which two layers of the wrapper material are adhered to each other, such as in a flow wrapper. Means for ejecting adhesive in the form of an image may be adapted from adhesive applicators (including spray nozzles and the like) that are currently available.

The foregoing description is for the purposes of illustration and is not to be deemed to limit the invention, which is defined by the following claims.

What is claimed is:

1. A tamper evident bunch wrap package for an edible product comprising:
a wrapping material conforming to an outside shape of the edible and having edges gathered on a surface of the product; and
an image formed on the gathered edges, such that opening the bunch wrap package provides evidence of tampering by visual corruption of the image.

2. The package according to claim 1, wherein the edges of the wrapping material are gathered on a flat side of the edible product.

3. The package according to claim 2, wherein the image has a width at least 25 percent the width of the flat side.

4. The package according to claim 2, wherein the width of the image is at least half the width of the flat side.

5. The package according to claim 2, wherein the image has a line width of at least about 1/16 inch.

6. The package according to claim 1, wherein the image is ink.

7. The package according to claim 1, wherein the image is a laser etching.

8. The package according to claim 1, wherein the image is formed from an adhesive.

9. The package according to claim 1, wherein the image is an embossed or debossed image.

10. The package according to claim 1, wherein the product is a molded chocolate piece.

11. The package according to claim 1, wherein the wrapper is a foil having dead fold properties and a thickness in a range of about 6 microns to about 40 microns.

12. A method for providing evidence of tampering to a bunch wrap package of an edible product comprising the steps of:
providing a product partially wrapped in a wrapping material;
gathering edges of the wrapping material on a surface of the product;
compressing the gathered edges of the bunch wrap package material; and
forming an image on the compressed gathered edges of the bunch wrap package material, wherein said image provides evidence of tampering by visual corruption of the image when the bunch wrap package is opened.

13. The method according to claim 12, wherein the step of providing a product partially wrapped in a wrapping material comprises pushing an edible product and a wrapping material through a die.

14. The method according to claim 12, wherein the compressing step comprises conveying individual wrapped pieces on a conveyor belt and compressing the gathered edges with a cooperating belt.

15. The method according to claim 14, wherein the cooperating belt is provided with an embossing or debossing design to form an image on the wrapped pieces.

16. The method according to claim 12, comprising the step of ejecting ink from an ink jet printhead to form the image.

17. The method according to claim 12, comprising the step of pressing an ink laden image onto the gathered edges of the bunch wrap package material with a contact member to form the image.

18. The method according to claim 12, comprising the step of laser etching a portion of the wrapper to form an image.

19. The method according to claim 12, wherein said product is individual bite sized molded chocolate pieces which are conveyed past an image forming station to form said image.

20. The method according to claim 12, wherein the image formed has a line width of at least about 1/16 inch and an image width at least 25 percent as wide as a flat side of the product on which the edges are gathered.
